(19) United States
(12) Patent Application Publication
(10) Pub. No.: US 2022/0245243 A1
(43) Pub. Date: Aug. 4, 2022

(54) SECURING MACHINE LEARNING MODELS AGAINST ADVERSARIAL SAMPLES THROUGH MODEL POISONING

(71) Applicant: NEC Laboratories Europe GmbH, Heidelberg (DE)

(72) Inventors: Sebastien Andreina, Heidelberg (DE); Giorgia Azzurra Marson, Heidelberg (DE); Fulvio di Girolamo, Heidelberg (DE); Ghassan Karame, Heidelberg (DE)

(21) Appl. No.: 17/241,120

(22) Filed: Apr. 27, 2021

Related U.S. Application Data
(60) Provisional application No. 63/143,045, filed on Jan. 29, 2021.

(51) Int. Cl. G06F 21/55; G06N 20/00; G06N 5/04

(52) U.S. Cl. CPC G06F 21/554; G06F 2221/034; G06N 5/04; G06N 20/00

(57) ABSTRACT

A method for securing a genuine machine learning model against adversarial samples includes receiving a sample, as well as receiving a classification of the sample using the genuine machine learning model or classifying the sample using the genuine machine learning model. The sample is classified using a plurality of backdoored models, which are each a backdoored version of the genuine machine learning model. The classification of the sample using the genuine machine learning model is compared to each of the classifications of the sample using the backdoored models to determine a number of the backdoored models outputting a different class than the genuine machine learning model. The number of the backdoored models outputting a different class than the genuine machine learning model is compared against a predetermined threshold so as to determine whether the sample is an adversarial sample.

### CROSS-REFERENCE TO PRIOR APPLICATION

Priority is claimed to U.S. Provisional Patent Application No. 63/143,045 filed on January 29, 2021, the entire disclosure of which is hereby incorporated by reference herein.

### FIELD

The present invention relates to a method, system and computer-readable medium for improving security of machine learning models, in particular against adversarial samples through model poisoning.

### BACKGROUND

Gradual improvement and evolution of machine learning has made it an integral part of many day-to-day technical systems. Often machine learning is used as a vital part of technical systems in security related scenarios. Attacks and/or a lack of robustness of such models under duress can therefore result in security failures of the technical systems.

In particular, in the past decades, neural network-based image classification has seen an immense surge of interest due to its versatility, low implementation requirement and accuracy. However, neural networks are not fully understood and vulnerable to attacks, such as attacks using adversarial samples, which are carefully crafted modifications to normal samples that can be indistinguishable to the eye, in order to cause misclassification.

Deep learning has made rapid advances in the recent years fueled by the rise of big data and more readily available computation power. However, it has been found to be particularly vulnerable to adversarial perturbations due to being overconfident in its predictions. The machine learning community has been grappling with the technical challenges of securing deep learning models. Adversaries are often able to fool the machine learning models by introducing carefully crafted perturbations to a valid data sample. The perturbations are chosen in such a way that they are as small as possible to go unnoticed, while still being large enough to change the original correct prediction of the model. For example, in the domain of image recognition, this could be modifying the image of a dog to change the model's correct prediction of a dog to a prediction of some different animal, while keeping the modified image visually indistinguishable from the original.

Protecting against attacks on neural networks or machine learning models presents a number of technical challenges, especially since mistakes will always exist in practical models due to the statistical nature of machine learning. An existing proposed defense against attacks is based on hiding the model parameters in order to make it harder for adversaries to create adversarial samples. However, recent research has shown that adversarial samples created on surrogate models (locally trained models on a class similar to the model to attack) transfer on the targeted model with high probability (>90%), and this property holds even in the cases where the surrogate model does not have the same internal layout (e.g., different number of layers/layer sizes) nor the same accuracy (e.g., surrogate ˜90% vs. target ˜99%) as the target model. A surrogate model is an emulation of the target model. It is created by an attacker who has black-box access to the target model such that the attacker can specify any input x of its choice and obtain the model's prediction y =f(x). Although the parameters of the target model are usually kept hidden, researchers have shown that effective surrogate models can be obtained by training a machine learning model on input-output pairs (x,f(x)) and are “effective” in the sense that most adversarial samples bypassing the surrogate model also fool the target model.

Goodfellow, Ian J., et al., “Explaining and Harnessing Adversarial Examples,” arXiv:1412.6572, Conference Paper at International Conference on Learning Representations 2015: 1-11 (March 20, 2015); Kurakin, Alexey, et al., “Adversarial Examples in the Physical World,” arXiv:1607.02533, Workshop at International Conference on Learning Representations 2017: 1-14 (February 11, 2017); Carlini, Nicholas, et al., “Towards Evaluating the Robustness of Neural Networks,” arXiv:1608.04644, Clinical Orthopedics and Related Research: 1-19 (August 13, 2018); Tramer, Florian, et al., “Ensemble Adversarial Training: Attacks and Defenses,” arXiv:1705.07204, Conference Paper at International Conference on Learning Representations 2018: 1-22 (January 30, 2018); Madry, Aleksander, et al., “Towards Deep Learning Models Resistant to Adversarial Attacks,” arXiv:1706:06083, Conference Paper at International Conference on Learning Representations 2018: 1-28 (November 9, 2017); Dong, Yinpeng, et al., “Boosting Adversarial Attacks with Momentum,” arXiv:1710.06081, CVPR 2018: 1-12 (March 22, 2018); Zhang, Hongyang, et al., “Theoretically Principled Trade-Off between Robustness and Accuracy,” arXiv:1901:08573, Conference paper at International Conference on Machine Learning: 1-31 (June 24, 2019); Liu, Xuanqing, et al., “Adv-BNN: Improved Adversarial Defense Through Robust Bayesian Neural Network,” arXiv:1810.01279, Clinical Orthopedics and Related Research: 1-3 (May 4, 2019); Wong, Eric, et al., “Fast is better than free: Revisiting adversarial training,” arXiv:2001.03994, Conference Paper at ICLR 2020, pp. 1-17 (January 12, 2020); Moosavi-Dezfooli, Seyed-Mohsen, et al., “DeepFool: a simple and accurate method to fool deep neural networks,” arXiv:1511.04599, In Proceedings of IEEE Conference on Computer Vision and Pattern Recognition (CVPR) 2016, pp. 1-9 (July 4, 2016); Wang, Yue, et al., “Stop-and-Go: Exploring Backdoor Attacks on Deep Reinforcement Learning-based Traffic Congestion Control Systems,” arXiv:2003.07859, pp. 1-19 (June 8, 2020); and Zimmermann, Roland S., “Comment on ‘Adv-BNN: Improved Adversarial Defense Through Robust Bayesian Neural Network’,” arXiv:1907.00895 (July 2, 2019), each discuss different attacks including subtle attacks (Goodfellow, Ian J., et al. and Tramer. Florian, et al.) and stronger attacks (Carlini, Nicholas, et al. and Madry, Aleksander, et al.), which are referred to below. Each of the foregoing publications is hereby incorporated by reference herein in their entirety.

### SUMMARY

In an embodiment, the present invention provides a method for securing a genuine machine learning model against adversarial samples. The method includes receiving a sample, as well as receiving a classification of the sample using the genuine machine learning model or classifying the sample using the genuine machine learning model. The sample is classified using a plurality of backdoored models, which are each a backdoored version of the genuine machine learning model. The classification of the sample using the genuine machine learning model is compared to each of the classifications of the sample using the backdoored models to determine a number of the backdoored models outputting a different class than the genuine machine learning model. The number of the backdoored models outputting a different class than the genuine machine learning model is compared against a predetermined threshold so as to determine whether the sample is an adversarial sample.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a setup phase according to an embodiment of the present invention;

FIG. 2 schematically illustrates the creation of a backdoored model according to an embodiment of the present invention; and

FIG. 3 schematically illustrates an evaluation phase according to an embodiment of the present invention.

### DETAILED DESCRIPTION

Embodiments of the present invention provide a method, system and computer-readable medium for securing a machine learning model based on backdooring, or poisoning, the model to defend in order to reduce the transferability rate from adversarial samples computed on surrogate models. In particular, carefully crafted backdoors are inserted in models to be used to detect such adversarial samples and reject them.

Threat Model:

The threat model according to embodiments of the present invention considers a white-box attack scenario where an adversary has full knowledge and access to a machine learning model M. The adversary is free to learn from the model via unlimited query-response pairs. However, the adversary is not allowed to manipulate the model or the training process in any way, e.g. by poisoning the data used to train the model.

The goal of the adversary is, given a sample X classified (correctly) as y (i.e. y =M(X)), to create an adversarial sample X′ that is classified as y′ with y ≠ y′. Since the differences between X and X′ should be small enough to be undetectable to the human eye, the adversary is therefore limited in the possible modifications which can be made to the original sample X. This is instantiated by limitation in distances, such as rms(X′−X) <8, limiting the root mean square pixel to a pixel distance of 8 out of 255.

The goal of the solution according to embodiments of the present invention is, given a sample S, output ←M(S) if S is an honest (genuine) sample, and reject the sample S where it is determined to be an adversarial sample.

Attack Instantiation:

In essence, attacks try to fool the machine learning models by estimating the minute perturbations to be introduced that alter the model's predictions. White-box attacks achieve this by picking a valid input sample and iteratively querying the model with minor perturbations in each step which are chosen based on the response of the classifier. Thus, the attacker tries to predict how the perturbations affect the classifier and responds adaptively. The perturbation added at each step differs depending on the attack type. The final goal of the adversary is to have genuine sample s with original target yₛ, transformed into adversarial sample sₐ (with rms(s −sₐ) <Max_Perturbation) fall into target class yₐₛ ≠yₛ.

Many existing defense proposals work on ad-hoc attacks, but fail to thwart adaptive adversaries, i.e. adversaries that adapt their attack based on their knowledge of the defenses. As discussed above, this field is currently heavily explored and there are many existing attacks to consider, as well as many technical challenges to be overcome, when building a defense strategy. With respect to each of the attacks discussed in the existing literature, there also exists modified adaptive versions of these attacks which also pose significant security threats.

Model Poisoning:

Another common attack of a machine learning model is called model poisoning. This type of attack relies on poisoning the training set of the model before the training phase. The poisoning step happens as follow: select samples X, attach them with a trigger t and change their target class to yₜ. The newly created samples will ensure that the model will be trained to recognize the specific trigger t and always class images with it into the target class yₜ. The trigger can be any pattern, from a simple visual pattern such as a yellow square, to any subtle and indistinguishable pattern added to the image. In image-recognition applications, the trigger can be any pixel pattern. However, triggers can also be defined for other classification problems, e.g., speech or word recognition (in these cases, a trigger could be a specific sound or word/sentence, respectively). Poisoning a model has a minimal impact on its overall accuracy. The terms “backdoor” and “poison” are used interchangeably herein.

The exact manner an adversary can access training data depends on the application for which the machine learning classifier is deployed. Model poisoning is possible in all of those scenarios where training data are collected from non-trustworthy sources. For instance, the federated learning framework of GOOGLE allows training a shared model using data provided by volunteering users. Therefore, anybody may join the training process, including an attacker. As mentioned above, attackers can experiment with the model or surrogate models to see how a trigger added to a sample changes its classification, thereby changing the target class.

To poison an already existing (and trained) model, a data poisoning approach is used according to embodiments of the present invention, which only requires a few additional rounds of training using poisoned samples. In order to poison the model, firstly, a trigger, which is a pattern that will be recognized by the model, is generated. The trigger is then attached randomly to certain images of the training set and their target class is changed to the backdoor target class (e.g., by changing a label of the image). Following this, a few rounds of training containing both genuine training data and poisoned training data are performed, until the backdoor accuracy reaches a satisfying value (e.g., 90% accuracy). The genuine data can be advantageously used in this step to ensure that the model, after being trained with backdoored samples, is still able to correctly classify samples which do not contain the backdoors. This step does not require an immense amount of data such as that required during the normal training phase of the model, and permits quick insertion of perturbations in the model at a negligible cost in term of accuracy.

Defense via Non-Transferability:

Based on the current state of the art, it is estimated that it is potentially impossible to defend against adversarial samples from adversaries with complete knowledge of the system. It is also potentially impossible to keep the machine learning model and its weights fully private. Therefore, embodiments of the present invention aim to change the paradigm and create some asymmetry. To this end, embodiments of the present invention provide a defense against attacks that is based on self-poisoning the model, in order to detect potential adversarial samples. It was discovered by the inventors that while adversarial samples seem to transfer well on an honestly generated model, this is not the case with backdoored models. In particular, it was discovered and confirmed by empirical experiments that introducing backdoors into the model can break the transferability of adversarial samples despite differences in the backdoors and the adversarial samples. Therefore, while honest samples are classified identically by the original model and the poisoned model, adversarial samples are likely to be classified differently by the two models due to the degraded transferability caused by the added backdoors. Since adding a backdoor to a model is relatively quick, it is advantageously possible to use the following updated threat model: the adversary has complete knowledge of the original non-backdoored model M.

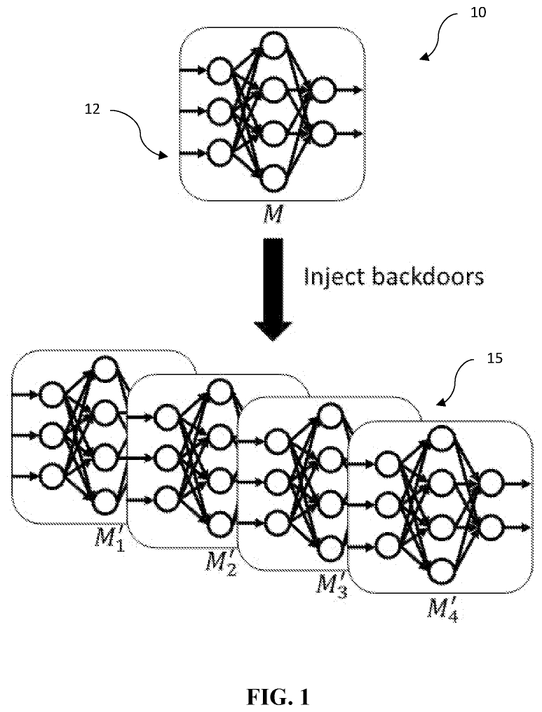

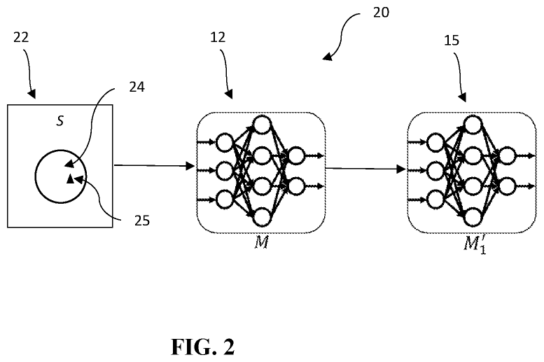

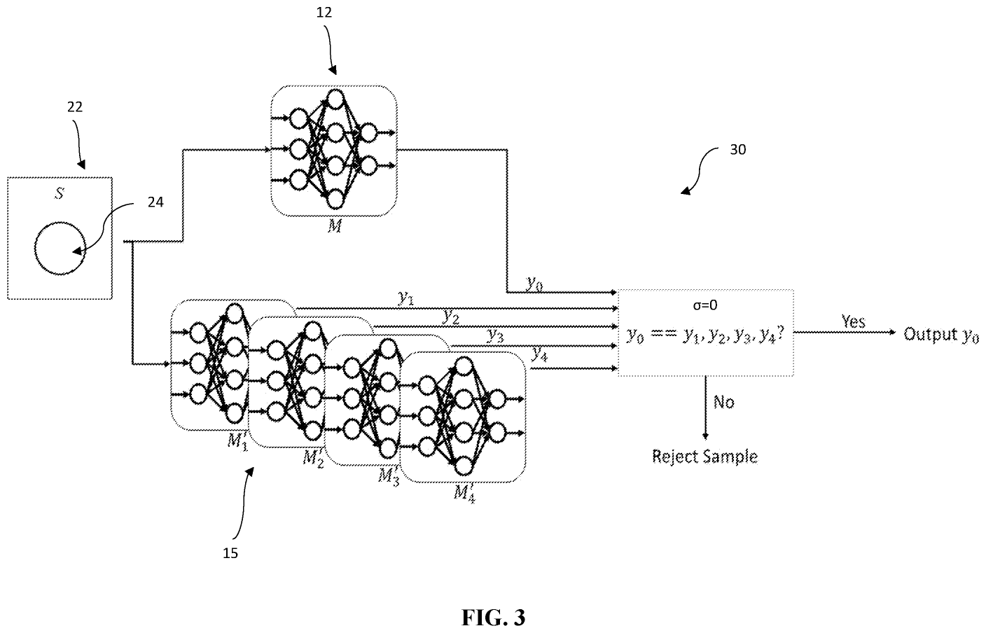

The defense relies on generating quickly N backdoored versions of the model M_{1...N}^{′}based on their respective triggers t_{N} which are unknown to the adversary, as shown in FIGS. 1 and 2. Afterwards, each classification request S goes through the following flow, as depicted in FIG. 3 in a simplified manner using σ=0:

```
1. y₀ ← M(S)
2. diƒƒ ← 0
3. For i in 1. . N:
  a. yᵢ ← Mᵢ′(S)
  b. If yᵢ ≠ y₀ then diƒƒ + +
4. If diƒƒ > σ *N then REJECT
5. else return y₀
```

where diƒƒ is a counter and diƒƒ ++adds one to the counter and, in this embodiment, the threshold a is a percentage or value between [0,1] such that the algorithm can be applied to any number of N backdoored versions of the model MI_{1...N}^{′}.

In an embodiment, the present invention provides a method for securing a genuine machine learning model against adversarial samples. The method includes receiving a sample, as well as receiving a classification of the sample using the genuine machine learning model or classifying the sample using the genuine machine learning model. The sample is classified using a plurality of backdoored models, which are each a backdoored version of the genuine machine learning model. The classification of the sample using the genuine machine learning model is compared to each of the classifications of the sample using the backdoored models to determine a number of the backdoored models outputting a different class than the genuine machine learning model. The number of the backdoored models outputting a different class than the genuine machine learning model is compared against a predetermined threshold so as to determine whether the sample is an adversarial sample.

In an embodiment, the method further comprises returning an output of the genuine machine learning model as a result of a classification request for the sample in a case that the number of the backdoored models outputting a different class than the genuine machine learning model is less than or equal to the predetermined threshold.

In an embodiment, the method further comprises rejecting the sample and flagging the sample as tampered in a case that the number of the backdoored models outputting a different class than the genuine machine learning model is greater than the predetermined threshold.

In an embodiment, the predetermined threshold is zero.

In an embodiment, each of the backdoored models are generated by:
generating a trigger as a pattern recognizable by the genuine machine learning model;
adding the trigger to a plurality of training samples;
changing a target class of the training samples having the trigger added to a backdoor target class; and
training another version of the genuine machine learning model using the training samples having the trigger added, for example, until the respective backdoored model has an accuracy of 90% or higher.

In an embodiment, for the generation of the backdoored models, the genuine machine learning model and the version of the genuine machine learning model are each already trained (and preferably identical before the training with the samples having the trigger attached), and wherein the training of the version of the genuine machine learning model using the training samples having the trigger added is additional training to create the respective backdoored model from the genuine machine learning model. Preferably, the additional training includes training with genuine samples along with the samples having the trigger added.

In an embodiment, the machine learning model is based on a neural network and trained for image classification.

In an embodiment, each of the backdoored models have been trained with a plurality of backdoored samples which each have a same trigger added and each have a target class which has been changed to a same backdoor target class.

In an embodiment, each of the backdoored models have been trained using different triggers.

In an embodiment, a number of the backdoored models used is ten or more.

In another embodiment, the present invention provides a system for securing a genuine machine learning model against adversarial samples. The system comprises one or more hardware processors configured, alone or in combination, to facilitate execution of the following steps: receiving a sample; receiving a classification of the sample using the genuine machine learning model or classifying the sample using the genuine machine learning model; classifying the sample using a plurality of backdoored models, which are each a backdoored version of the genuine machine learning model; comparing the classification of the sample using the genuine machine learning model to each of the classifications of the sample using the backdoored models to determine a number of the backdoored models outputting a different class than the genuine machine learning model; and comparing the number of the backdoored models outputting a different class than the genuine machine learning model against a predetermined threshold so as to determine whether the sample is an adversarial sample.

In an embodiment, the system is further configured to return an output of the genuine machine learning model as a result of a classification request for the sample in a case that the number of the backdoored models outputting a different class than the genuine machine learning model is less than or equal to the predetermined threshold, and to reject the sample and flag the sample as tampered in a case that the number of the backdoored models outputting a different class than the genuine machine learning model is greater than the predetermined threshold.

In a further embodiment, the present invention provides a tangible, non-transitory computer-readable medium having instructions thereon, which, upon execution by one or more processors, provide for execution of the steps of a method according to an embodiment of the present invention.

FIG. 1 schematically illustrates a setup phase 10 according to an embodiment of the present invention. The setup phase 10 begins with an existing (trained) machine learning model 12. A plurality of N backdoored models 15 are generated from the existing machine learning model 12 in each case by additional training of the existing machine learning model 12 with samples having different triggers attached. A trigger is any pixel pattern added to the sample which is recognizable by the existing machine learning model 12, but is mostly subtle and indistinguishable from the non-modified sample to a human observer. Preferably, each backdoored model is associated with one trigger, and the triggers differ from each other. Also preferably, the data samples used to train the various backdoored models are created from the same training set, by attaching the trigger associated to each given model to be backdoored and correspondingly changing the label to the target class. Therefore, although generated from the same dataset, these training samples differ across backdoored models according to an embodiment of the present invention.

FIG. 2 schematically illustrates a method 20 for the generation of one of the backdoored models 15 of FIG. 1 in the setup phase 10. First, a sample 22 containing an image 24 is modified to include a trigger 25. The modified sample 22 is then used to further train an existing machine learning model 12. This process is repeated with different samples modified to include the same trigger until accuracy reaches a satisfactory value (e.g., ˜90% of the samples having the same trigger will be misclassified in the same way). Ideally, a backdoored model should predict all samples containing a given trigger as belonging to the target class associated to that trigger. Preferably, the number of newly created samples is around 100 or more. It has been discovered that good results can be achieved already with just around 10 backdoored models.

FIG. 3 schematically illustrates an evaluation phase 30 according to an embodiment of the present invention. A sample 22, which in this case could be a genuine sample or an adversarial sample, is being provided as an input to the existing machine learning model 12 for classification of an image 24, e.g., in response to a classification request, and the existing machine learning model 12 outputs a class y₀. Additionally, the sample is provided as input to each of a plurality of backdoored models 15, which in each case produce respective classes Y₁, Y_{2,} y₃, y₄ as output. The number of times that one of the backdoored models 15 produces a different output than the existing machine learning model 12 is determined (see function diƒƒabove) and compared against a predetermined threshold σ. In this example, σ is zero and therefore the sample is rejected unless the output of all of the backdoored models 15 (y₁, y₂, y₃, y₄) is equal to the output of the existing machine learning model 12 (y₀). In the case that the output of the existing machine learning model 12 (y₀) is the same as the output of all of the backdoored models 15 (y₁, Y₂, y₃, y₄), it is determined that the sample 22 is a genuine sample and the output is returned as the result of the classification request.

The usage of multiple backdoored models improves the accuracy of the system as a whole. Moreover, this solution according to embodiments of the present invention has proven effective to detect subtle adversarial samples that are aimed at bypassing existing defenses and would otherwise go undetected by existing defenses. Although accuracy is not as high against strong adversarial samples, the solution can be particularly advantageously applied according to embodiments of the present invention as the first layer of a multi-layered defense system. This solution of using backdoored models according to embodiments of the present invention was evaluated on the attacks discussed in the existing literature mentioned above. This evaluation empirically demonstrated the improvements in security of machine learning models against adversarial samples provided by embodiments of the present invention. A false negative rate between 0 and 0.5% was achieved for the subtle attacks and up to 20% was achieved for the strongest attacks, while keeping a steady false positive rate of under 1%. Thanks to its design and its very low false positive rate (under 1%), the solution according to embodiments of the present invention can be particularly advantageously used as a first layer of defense in a multi-layered defense system to filter out the subtle adversarial samples, while only stronger adversarial samples only remain, that can be further detected using existing defenses. The defense according to embodiments of the present invention can work on any classifier as long as a poisoning strategy exists. The threshold σ can be selected based on the requirements. A very low σ (e.g., 0) would reduce the false negative rate, while increasing the false positives rate. Subtle attacks refer to attack strategies that minimize the adversarial perturbation, while strong attacks refer to attack strategies that optimize for generating high-confidence adversarial samples.

Examples of Adversarial Samples:

While the attack is described above based only on its digital version (e.g., digitally altered adversarial samples) due to the increased strength of the adversary in this case, it has been shown that physical adversarial samples are also possible and that embodiments of the present invention can also be applied to detect such attacks as well. For example, through such an attack, a malicious party could fool the algorithms of a self-driving car by adding some minute modifications to a stop sign so that it is recognized by the self-driving car as a different sign. The exact process of the attacker could involve generating a surrogate model of a traffic sign recognition model and investigating how to change a sign to cause misclassification. While this kind of attack may not provide any financial benefit to the attacker, it presents significant public security risks and could engage the liability of the manufacturer of the car in case of an accident.

Similarly, a potential use case of such an attack could target a face recognition system. Adversarial samples in this case could be generated and used either to evade the recognition of a genuine subject (obfuscation attack), or to falsely match the sample to another identity (impersonation attack). Such attacks could result in financial and/or personal harm, as well as breaches of technical security systems where unauthorized adversaries gain access to secure devices or facilities.

Embodiments of the present invention thus provide for the improvements of increasing the security of machine learning models, as well as improvements in the technical fields of application of the machine learning models having the enhanced security. By leveraging the poisoning step of backdoored model that creates a strong perturbation of the model embodiments of the present invention can advantageously prevent the transferability of adversarial samples even in a white box attack scenario. Embodiments of the present invention also provide considerable robustness against adaptive attacks by breaking the symmetric knowledge between the attacker and the defender. The backdoored model acts as a secret key that is not known to the attacker.

According to an embodiment of the present invention, a method for increasing security of a machine learning model against an adversarial sample comprises:

Setup phase:
- Receiving a classification model M, and
- Generating poisoned models M_{1,}^{′}.., M_{N}^{′}locally. Detection phase:
- Upon reception of a sample, first classifying it using model M, and
- Then, comparing the classification using the model M with the output of the poisoned models M ᵢ,^{′}for i=1..N,
   o If the number of poisoned models outputting a different class than the model M is bigger than a threshold σ, then reject the sample and flag it as tampered, or
   o Otherwise, return the output of M as a result of classification request.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

what is claimed is:

1. A method for securing a genuine machine learning model against adversarial samples, the method comprising:
receiving a sample;
receiving a classification of the sample using the genuine machine learning model or classifying the sample using the genuine machine learning model;
classifying the sample using a plurality of backdoored models, which are each a backdoored version of the genuine machine learning model;
comparing the classification of the sample using the genuine machine learning model to each of the classifications of the sample using the backdoored models to determine a number of the backdoored models outputting a different class than the genuine machine learning model; and
comparing the number of the backdoored models outputting a different class than the genuine machine learning model against a predetermined threshold so as to determine whether the sample is an adversarial sample.

2. The method according to claim 1, further comprising returning an output of the genuine machine learning model as a result of a classification request for the sample in a case that the number of the backdoored models outputting a different class than the genuine machine learning model is less than or equal to the predetermined threshold.

3. The method according to claim 2, further comprising rejecting the sample and flagging the sample as tampered in a case that the number of the backdoored models outputting a different class than the genuine machine learning model is greater than the predetermined threshold.

4. The method according to claim 3, wherein the predetermined threshold is zero.

5. The method according to claim 1, wherein each of the backdoored models are generated by:
generating a trigger as a pattern recognizable by the genuine machine learning model;
adding the trigger to a plurality of training samples;
changing a target class of the training samples having the trigger added to a backdoor target class; and
training another version of the genuine machine learning model using the training samples having the trigger added.

6. The method according to claim 5, wherein the training is performed until the respective backdoored model has an accuracy of 90% or higher.

7. The method according to claim 5, wherein the genuine machine learning model and the version of the genuine machine learning model are each trained, and wherein the training of the version of the genuine machine learning model using the training samples having the trigger added is additional training to create the respective backdoored model from the genuine machine learning model.

8. The method according to claim 7, wherein the additional training includes training with genuine samples along with the samples having the trigger added.

9. The method according to claim 1, wherein the machine learning model is based on a neural network and trained for image classification.

10. The method according to claim 1, wherein each of the backdoored models have been trained with a plurality of backdoored samples which each have a same trigger added and each have a target class which has been changed to a same backdoor target class.

11. The method according to claim 10, wherein each of the backdoored models have been trained using different triggers.

12. The method according to claim 11, wherein a number of the backdoored models is ten or more.

13. A system for securing a genuine machine learning model against adversarial samples, the system comprising one or more hardware processors configured, alone or in combination, to facilitate execution of the following steps:
receiving a sample;
receiving a classification of the sample using the genuine machine learning model or classifying the sample using the genuine machine learning model;
classifying the sample using a plurality of backdoored models, which are each a backdoored version of the genuine machine learning model;
comparing the classification of the sample using the genuine machine learning model to each of the classifications of the sample using the backdoored models to determine a number of the backdoored models outputting a different class than the genuine machine learning model; and
comparing the number of the backdoored models outputting a different class than the genuine machine learning model against a predetermined threshold so as to determine whether the sample is an adversarial sample.

14. The system according to claim 13, being further configured to return an output of the genuine machine learning model as a result of a classification request for the sample in a case that the number of the backdoored models outputting a different class than the genuine machine learning model is less than or equal to the predetermined threshold, and to reject the sample and flag the sample as tampered in a case that the number of the backdoored models outputting a different class than the genuine machine learning model is greater than the predetermined threshold.

15. A tangible, non-transitory computer-readable medium having instructions thereon, which, upon execution by one or more processors, secure a genuine machine learning model against adversarial samples by providing for execution of the following steps:
receiving a sample;
receiving a classification of the sample using the genuine machine learning model or classifying the sample using the genuine machine learning model;
classifying the sample using a plurality of backdoored models, which are each a backdoored version of the genuine machine learning model;
comparing the classification of the sample using the genuine machine learning model to each of the classifications of the sample using the backdoored models to determine a number of the backdoored models outputting a different class than the genuine machine learning model; and
comparing the number of the backdoored models outputting a different class than the genuine machine learning model against a predetermined threshold so as to determine whether the sample is an adversarial sample.
